(19) United States
(12) Patent Application Publication
(10) Pub. No.: US 2004/0065101 A1
(43) Pub. Date: Apr. 8, 2004

(54) Vehicle climate control system

(75) Inventors: Eric Krupp, Canton, MI (US); Todd DePue, Brighton, MI (US); Jack Palazzolo, Kewadin, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI

(21) Appl. No.: 10/266,972

(22) Filed: Oct. 8, 2002

(51) Int. Cl. F25B 21/02; F25B 9/00; B60H 1/32

(52) U.S. Cl. 62/244; 62/3.3; 62/6

(57) ABSTRACT

A climate control system for a passenger compartment of a vehicle is provided that includes a ventilation fan for facilitating movement of air out of the passenger compartment of the vehicle. The fan is selectively controlled by an electronic control unit, which receives a signal from a temperature sensor indicating that operation of the fan is needed. A plurality of thermoelectric devices are used to control the temperature of the ambient air in the passenger compartment. In addition, the vehicle seats are each equipped with at least one thermoelectric device to heat and cool each seat individually. A retractable window cover may optionally be provided to reduce transmission of infrared light into the vehicle interior. The combination of the ventilation fan, the thermoelectric devices for each seat and for the ambient air, and the optional retractable window cover allows for the elimination of the vehicle's central air conditioning system.

### BACKGROUND OF THE INVENTION

1. Field of the Invention

The present invention relates to a system and method of vehicle climate control.

2. Background Art

Effectively controlling the climate in a vehicle interior is an important part of ensuring driver and passenger comfort. It is often desirable to control the climate in the vehicle interior for a short time prior to the driver and passengers entering the vehicle. This type of control helps to provide the vehicle occupants with a comfortable atmosphere upon initial entry into the vehicle. This is in contrast to an engine operated climate control system, which only operates after the engine is running-usually after the driver and passengers have entered the vehicle. In addition, many engine operated climate control systems rely on a centralized air conditioning system, which has a number of limitations. For example, different vehicle occupants may desire different levels of cooling, and a centralized air conditioning system may not provide adequate control to meet the individuals' needs. In addition, a large capacity central air conditioning system, particularly a vapor-compression system, can consume an undesirable amount of engine power and add an unacceptable amount of weight to the vehicle, thereby reducing the vehicle's efficiency.

There currently exists a wide variety of climate control systems that attempt to address some of these requirements. One example is found in U.S. Pat. No. 6,158,225 issued to Muto et al. on Dec. 12, 2000. Muto et al. describes an automotive air conditioning apparatus that includes a pre-cooling device for use when the vehicle is parked and not running, and a cooling device for use when the vehicle engine is running. The pre-cooling device includes a ventilation fan and a thermoelectric device, operated based on inputs to a sub-controller. The cooling device is engine driven, and may comprise the vehicle's central air conditioning system. One limitation of the apparatus described in Muto et al. is the reliance on a central air conditioning system, which may not provide the individualized control desired by the vehicle occupants.

Another example of a type of climate control system is a heat control apparatus described in U.S. Pat. No. 4,920,759 issued to Tanaka et al. on May 1, 1990. Tanaka et al. describes a radiant heat control apparatus that includes a number of radiant heat sensors positioned in various locations throughout the vehicle interior, such as on the occupant seats. In addition, temperature sensors may be located in positions throughout the vehicle interior. The radiant heat sensors and the temperature sensors signal a controller, which then controls operation of heating and cooling devices located throughout the vehicle interior. The heating and cooling devices are utilized to try to minimize radiant heat transfer between the vehicle occupants and the vehicle.

Tanaka et al. does not provide for climate control prior to vehicle entry; therefore, it may take an undesirable amount of time after entry into the vehicle for the interior to become comfortable to the occupants. Moreover, neither the Tanaka et al. apparatus, nor the Muto et al. apparatus directly controls the temperature of the seats. Because the seats may act as a heat or cold sink, it may be important to the comfort level of a vehicle occupant to adjust the temperature of the occupied seat.

Thus, there remains a need for a vehicle climate control system that can control the climate in a passenger compartment of a vehicle prior to the driver and passengers entering the vehicle, and can provide individualized control of the climate for each of the occupants, while increasing the efficiency of the vehicle by eliminating a centralized vapor-compression air conditioning system.

### SUMMARY OF THE INVENTION

It is an aspect of the invention to provide a vehicle climate control system that is capable of controlling the climate in the passenger compartment of a vehicle prior to the driver and passengers entering the vehicle.

It is another aspect of the invention to provided a vehicle climate control system that allows for individualized climate control by the vehicle occupants, including control of the occupant's seat temperature.

It is yet another aspect of the invention to provide a vehicle climate control system that reduces costs and increases vehicle efficiency by obviating the need for a centralized vapor-compression air conditioning system.

Accordingly, a climate control system for controlling the climate in a passenger compartment of a vehicle having a seat is provided. The climate control system comprises a first heating and cooling mechanism disposed in relation to the seat for selectively heating and cooling the seat. A second heating and cooling mechanism is also provided for selectively heating and cooling ambient air in the vehicle passenger compartment. The climate control system includes a fan for facilitating movement of air out of the vehicle passenger compartment. An electronic control system is provided for controlling the operation of the first and second heating and cooling mechanisms, and the fan. A signaling device is included for selectively signaling the electronic control system to activate and deactivate the fan prior to an occupant entering the vehicle.

Another aspect of the invention provides a climate control system for controlling the climate in a passenger compartment of a vehicle without a vapor-compression air conditioning system, the vehicle having a plurality of seats. The climate control system comprises a passenger compartment ventilation system including a fan for facilitating movement of air out of the vehicle passenger compartment. A first set of heating and cooling mechanisms is disposed in relation to the seats for selectively heating and cooling the seats. A second set of heating and cooling mechanisms is disposed in relation to the vehicle passenger compartment for selectively heating and cooling the ambient air in the passenger compartment of the vehicle. An electronic control system controls operation of the first set of heating and cooling mechanisms, the second set of heating and cooling mechanisms, and the fan. A signaling device selectively signals the electronic control system to activate and deactivate the fan prior to an occupant entering the vehicle.

Yet another aspect of the invention provides a method of controlling the climate in a passenger compartment of an engine driven vehicle having a seat. The method comprises sensing the temperature of ambient air in the vehicle passenger compartment before the engine is turned on. A first signal, related to the temperature of the ambient air, is sent to an electronic control unit, which processes the first signal. Based on the processing of the first signal, the electronic control unit selectively operates a fan, which is configured to facilitate movement of air out of the passenger compartment of the vehicle. After the engine is turned on, the temperature near the interface of a seated occupant and the seat is sensed, and a second signal, related to the temperature near the interface, is sent to the electronic control unit. Also after the engine is turned on, the temperature of ambient air in the vehicle interior is sensed, and a third signal, related to the temperature of the ambient air, is sent to the electronic control unit. The electronic control unit processes the second and third signals, and selectively operates at least one climate control device, chosen from a seat of climate control devices. The selective operation of the at least one climate control device is based on the processing by the electronic control unit. The set of climate control devices includes a first heating and cooling mechanism disposed in relation to the seat for selectively heating and cooling the seat, and a second heating and cooling mechanism disposed in the passenger compartment of the vehicle for selectively heating and cooling ambient air in the vehicle interior.

The above object and other objects, features, and advantages of the present invention are readily apparent from the following detailed description of the best modes for carrying out the invention when taken in connection with the accompanying drawings.

### BRIEF DESCRIPTION OF THE DRAWINGS

FIG. 1 shows a schematic representation of a climate control system in accordance with the present invention;

FIG. 2 shows a fragmentary view of a portion of a passenger compartment of a vehicle; and

FIG. 3 is a flow chart illustrating one method of controlling the climate in a passenger compartment of a vehicle in accordance with the present invention.

### DETAILED DESCRIPTION OF THE PREFERRED EMBODIMENT(S)

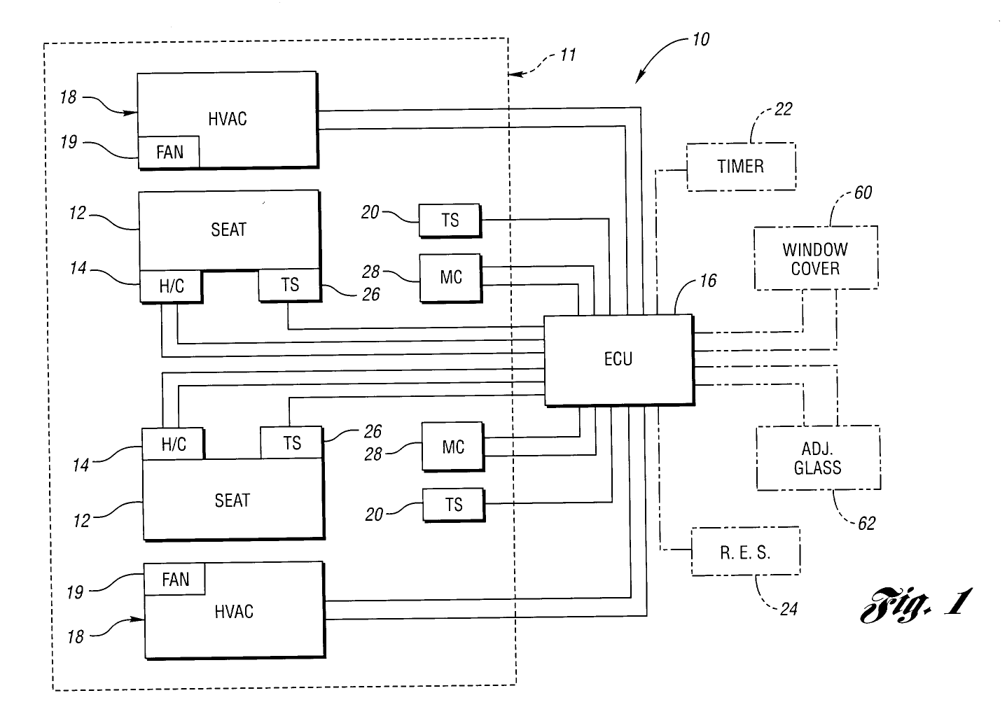

FIG. 1 schematically illustrates a climate control system 10 for use in a passenger compartment 11 of a vehicle in accordance with the present invention. Seats 12 are each configured with a first heating and cooling mechanism, such as a thermoelectric device 14. Although FIG. 1 illustrates two seats—for example, the front seats in a vehicle—every seat in the vehicle, or indeed only a single seat, may be configured with a thermoelectric device 14. The thermoelectric devices 14 work on the Peltier effect, in which an electric current is run across dissimilar semiconductor elements (such as N-type and P-type elements), to create a temperature differential. Vehicle seats configured with thermoelectric devices, such as the thermoelectric devices 14, are readily available to vehicle designers and manufacturers. This can reduce the overall vehicle cost by eliminating the need to custom fit the vehicle seats with the heating and cooling mechanisms. Alternatively, the seats could be of a custom design, configured with thermoelectric devices or other types of heating and cooling mechanisms, such as Stirling cycle devices.

The thermoelectric devices 14 are connected to, or otherwise in communication with, an electronic control system comprising an electronic control unit (ECU) 16, which is used to control the operation of the thermoelectric devices 14. The ECU 16 is also connected to, and can be used to control, second heating and cooling mechanisms, such as heating, ventilating, and air conditioning (HVAC) systems 18. Alternatively, the electronic control system may comprise multiple electronic control units, with each one configured to control one or more of the elements of the climate control system. Furthermore, such multiple electronic control units may be configured to communicate with each other and/or with a main electronic control unit.

In the embodiment illustrated in FIG. 1, the HVAC systems 18 are also thermoelectric devices, but again, the use of other heating and cooling mechanisms, such as Stirling cycle devices is contemplated. The HVAC systems 18 are disposed in relation to the vehicle passenger compartment, for selectively heating and cooling the ambient air. For example, HVAC systems 18 may be located in the instrument panel, the headliner, door panels, and/or other interior panels. The exact number and location of HVAC systems can be varied, depending on a number of factors. For example, differently sized vehicles may have different heating and cooling requirements, as well as more or less space available in which to locate an HVAC system. Thus, the present invention is flexible enough to be utilized across many vehicle platforms.

In addition to providing heated and cooled air into the passenger compartment of the vehicle, the HVAC systems 18 can also be utilized for ventilation. In the embodiment illustrated in FIG. 1, a passenger compartment ventilation system includes fans 19, each of which is part of a corresponding HVAC system 18. The fans 19 can be used to move air into, or out of, the passenger compartment of the vehicle. In an alternative embodiment, the fans may be standalone devices—i.e., separate from any HVAC system. An HVAC system, such as the HVAC system 18, may have a single fan or may have more than one fan. When a single fan is employed, it may be convenient to use a reversible fan—i.e., one that is capable of exhausting air from the passenger compartment to the vehicle exterior, and blowing heated or cooled air from the HVAC into the passenger compartment. When an HVAC system is configured with more than one fan, the different fans could be oriented in different directions—i.e., one or more fans could exhaust air, while one or more fans could blow air into the passenger compartment.

Control of the fans 19 is effected by the ECU 16, which is configured to receive a first signal from a signaling device such as a first temperature sensor 20, two of which are illustrated in FIG. 1. The first temperature sensors 20, which may be of any suitable type—e.g., a thermocouple—are configured to sense the temperature of the ambient air in the passenger compartment of the vehicle. A single temperature sensor may be used, or as illustrated in FIG. 1, multiple sensors 20 can provide input to the ECU 16. Thus, in the embodiment illustrated in FIG. 1, the passenger compartment ventilation system also includes the first temperature sensors 20 and the ECU 16. Of course, the use of other passenger compartment ventilation systems is contemplated. For example, a passenger compartment ventilation system may have its own electronic control unit, configured to control only the fan. Yet another passenger compartment ventilation system may receive inputs from different types of signaling devices.

The ECU 16 is configured to operate the fans 19 to ventilate the passenger compartment of the vehicle even when the engine is not running, and in particular, prior to the driver and/or passengers entering. The ECU 16 contains a preprogrammed algorithm for processing input signals, such as the first signal from the first temperature sensors 20, and for determining which climate control devices to operate. As explained more fully below, the ECU 16 may activate the fans 19 when the temperature sensed by the first temperature sensors 20 exceeds a predetermined value. Because the fans 19 can be operated when the vehicle engine is not running, they may, in such situations, be powered by the vehicle battery, or the vehicle may be equipped with a solar panel to provide electricity without draining the battery.

The operation of the fans 19 may be based on the inputs from temperature sensors, such as the first temperature sensors 20, or alternatively, the operation of the fans 19 may be based on inputs from other signaling devices. For example, a timer 22, illustrated in phantom in FIG. 1, may be used to signal the ECU 16 to ventilate the passenger compartment of the vehicle. The vehicle driver could program the timer 22 with a first predetermined time, so that at the given time, the ECU 16 would be signaled to activate at least one of the fans 19. The first predetermined time could be set to precede the driver's planned re-entry into the vehicle, thereby ventilating the passenger compartment before the driver returns. In addition, the timer 22 may also be programmed with a second predetermined time, so the ECU 16 would deactivate the fan after a fixed period. Thus, if the driver does not return to the vehicle as planned, the fan will not unnecessarily drain the battery.

The use of other types of signaling devices is also contemplated. For example, a portion of a remote entry system 24, illustrated in phantom in FIG. 1, may be used to send the first signal the ECU 16 to activate the fans 19. In this embodiment, just prior to entering the vehicle, the driver sends a signal to the vehicle's remote entry system—a signal which may cause the doors to unlock, an alarm system to disarm, and may even start the vehicle engine. In addition, the signal can be configured to provide the ECU 16 with an input that activates the fans 19 to ventilate the passenger compartment of the vehicle. Thus, there are any number of signaling devices that can be used to signal the ECU 16 to activate the fans 19 prior to the driver and/or passengers entering the vehicle.

In addition to the inputs received from one or more of the signaling devices such as the first temperature sensors 20, the timer 22, and the remote entry system 24, the ECU 16 is also configured to receive inputs from second temperature sensors 26 and from manual controllers 28. The second temperature sensors 26 and the manual controllers 28 are capable of sending input signals to the ECU 16 when the engine is running. The second temperature sensors 26 are disposed in relation to the seats 12—i.e., they are located on or near the seats 12—for sensing the temperature of a portion of the seats 12, and for sending a signal to the ECU 16. The ECU 16 processes the signal sent from the second temperature sensors 26, and uses this to selectively operate the first heating and cooling mechanisms 14. Of course, the first temperature sensors 20 may continue to operate after the vehicle engine has been started, and they can continue to send signals to the ECU 16 related to the temperature of the ambient air within the passenger compartment of the vehicle. Thus the ECU 16 may operate the HVAC systems 18 and the thermoelectric devices 14 based on the processing of signals from a number of input devices.

The manual controllers 28 provide yet another input into the ECU 16. For example, a vehicle occupant may input a desired temperature into one of the manual controllers 28. The desired temperature may be for the occupied seat, the ambient air surrounding the seat, or both. The manual controller 28 would then signal the ECU 16, which would compare this input with the temperatures sensed by the first and second temperature sensors 20, 26. The ECU 16 would then selectively operate one or more of the thermoelectric devices 14 and the HVAC systems 18 based on the processing of the inputs. Alternatively, the vehicle occupant may use the manual controller 28 to manually operate the thermoelectric devices 14 and/or the HVAC systems 18.

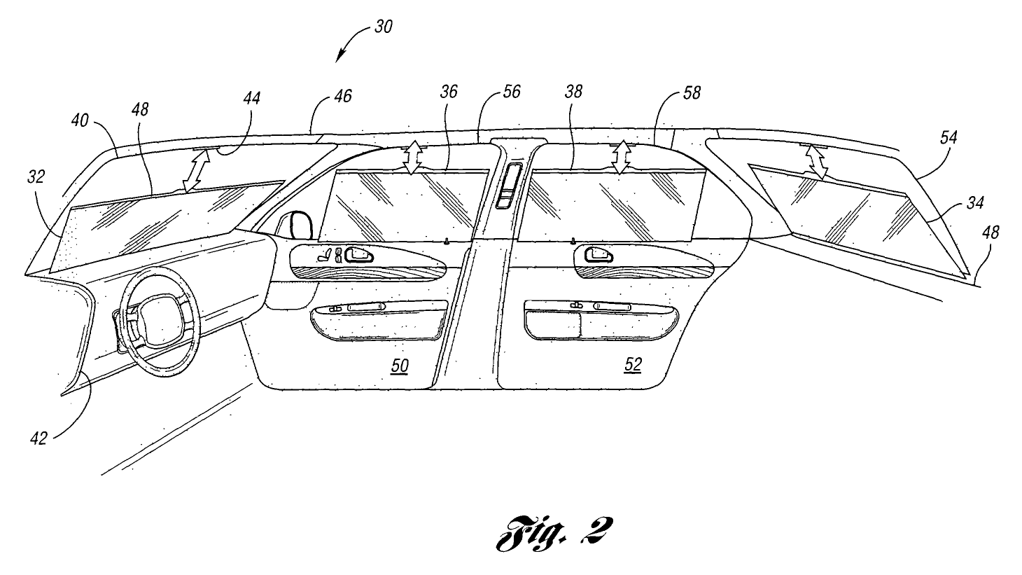

The climate control system 10 may also include additional elements which help to keep the passenger compartment of the vehicle cool, thereby contributing to occupant comfort, particularly in warm weather. For example, FIG. 2 shows a passenger compartment 30 of a vehicle configured with retractable window covers 32, 34, 36, and 38. The window cover 32 has an extended position to cover a windshield 40, and a retracted position for storage in an instrument panel 42. A rail latch 44 is attached to a front roof rail 46 to provide a point of attachment for the window cover 32 when it is in the extended position. The window cover 32 can be made from any suitable material-e.g., an opaque or partially opaque polymeric sheet-that blocks sunlight and that can be repeatedly rolled and unrolled to and from the instrument panel 42. The window cover 32 is provided with a structural rail 48 along a top edge of the cover. The structural rail 48 facilitates extension and retraction of the widow cover 32, and facilitates easy attachment to the rail latch 44.

The window cover 32, shown in FIG. 2, is configured to be manually operated. That is, when the vehicle is parked in a location where it will be exposed to sunlight, the driver can grasp the window cover 32 at the structural rail, unroll it from the retracted position within the instrument panel 42, and attach it to the rail latch 44. Similarly, the window covers 34, 36, 38 can be extended from a retracted position within interior panels 48, 50, 52 to cover a rear window 54 and side windows 56, 58, respectively. It should be noted that two additional window covers (not shown) are installed on the driver's side of the passenger compartment 30, to selectively cover the driver's side windows. Like the window cover 32, the window covers 34, 36, 38 are manually operated; however, any one or more of the window covers in a vehicle could be provided with a motor for extension and retraction.

Returning to FIG. 1, a retractable window cover 60 is schematically illustrated. The window cover 60 has a motor (not shown) for extension and retraction, that is connected to the ECU 16. In such a configuration, the driver of a vehicle could manually signal the ECU 16 to extend and retract the window cover 60, for example, by using a manual controller, such as the manual controller 28. Alternatively, the ECU 16 could be configured such that when the engine is not running, the window cover 60 is automatically extended when the temperature sensed by the temperature sensors 20 hits a predetermined temperature. This would help keep the passenger compartment of the vehicle cool, thereby reducing the use of the fans 19, while making the vehicle more comfortable for occupants upon entry.

As an alternative to providing the windows with retractable window covers, window glass can be provided that selectively blocks at least some of the infrared light from the sun, thereby helping to keep the passenger compartment of the vehicle cool. FIG. 1 schematically illustrates a window having light transmissivity adjustable glass 62 connected to the ECU 16. As in the case of the motor-driven retractable window covers, the ECU 16 may be configured to selectively reduce the amount of light entering through the adjustable glass 62 when the ECU 16 receives an appropriate signal from an input device, such as one of the manual controllers 28 or the temperature sensors 20, 26. The adjustable glass 62 may be controlled by the selective application of an electric current, as provided, for example, by the ECU 16. Alternatively, photochromic glass—i.e., glass that darkens when exposed to light—may be used, in which case the glass would automatically darken to reduce the amount of light entering the passenger compartment of the vehicle.

Window covers and light transmissivity adjustable glass are two ways to keep the vehicle cool to reduce reliance on air conditioning systems, and in particular, a centralized vapor-compression air conditioner. The present invention also contemplates the selective use of additional insulation in various areas of the vehicle. For example, space between a headliner and a roof panel is often entirely uninsulated. Similarly, some interior body panels may have little or no insulation between them and outer body panels. Insulation can be provided where none exists, or additional insulation added where there is initially very little. This would not only help keep the passenger compartment of the vehicle cooler in hot weather, but would help keep it warmer in cold weather, thus providing a more comfortable environment for the occupants upon entry, while at the same time reducing reliance on cooling and heating systems. The use of additional insulation, in conjunction with the other elements of the present invention, provides an effective climate control system for passenger compartment of a vehicle.

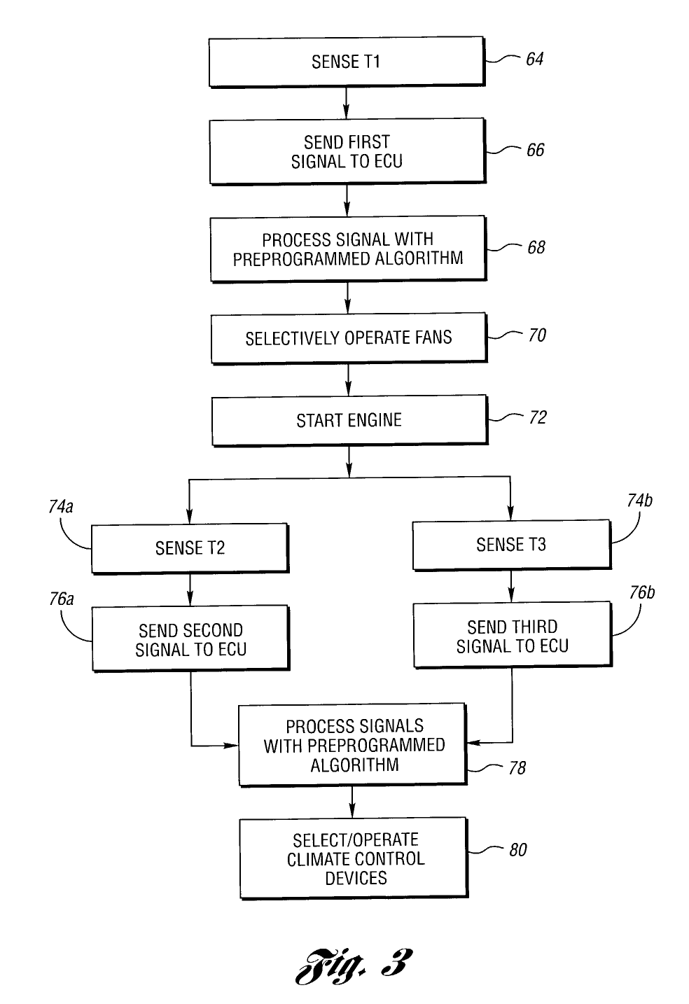

The present invention also includes a method of controlling the climate in a passenger compartment of a vehicle. Referring to FIG. 1 in conjunction with FIG. 3, the method is herein described. In step 64, the temperature (T1) of the ambient air in the passenger compartment of a vehicle is sensed by first temperature sensors prior to the occupants entering the vehicle, and preferably while the engine is not running. This task may be performed, for example, by the first temperature sensors 20 in the passenger compartment 11. A first signal, related to T1, is sent to an electronic control unit such as the ECU 16 (see block 66).

The first signal is then processed by the ECU 16, using a preprogrammed algorithm, as represented in block 68. The processing by the ECU 16 includes comparing the first signal to a first predetermined temperature to determine a first temperature differential. The first predetermined temperature may be a parameter programmed into the preprogrammed algorithm, or may be input by a vehicle occupant using a manual controller, such as the controller 28. If the first temperature differential indicates that the temperature of the ambient air within the passenger compartment of the vehicle exceeds the first predetermined temperature, the ECU 16 will activate the fans 19 (see block 70). The temperature sensors 20 may send additional signals to the ECU 16, such that the ECU 16 will deactivate the fans 19 when the ambient air in the passenger compartment is sufficiently lowered. Alternatively, the ECU 16 may operate the fans 19 for a set duration, the duration being programmed into the preprogrammed algorithm or input by an occupant using a manual controller.

In step 72 the vehicle engine is started, either after the driver enters the vehicle, or through the use of a remote entry system. At this point, two additional temperatures (T2) and (T3) are sensed (see blocks 74a and 74b). The temperatures T2, T3 may be sensed simultaneously, or in any order. A temperature sensor, such as one of the temperature sensors 26, senses the temperature T2 near the interface of a vehicle occupant and an occupied seat, and sends a second signal, related to the temperature sensed, to the ECU 16 (see block 76a). A temperature sensor, such as one of the temperature sensors 20, senses the temperature T3 of the ambient air in the passenger compartment of the vehicle, and sends a third signal, related to the temperature of the ambient air, to the ECU 16 (see block 76b). The temperatures T1 and T2 may each be sensed with multiple temperature sensors, in which case the second and third signals will actually be a series of signals.

After the second and third signals have been sent to the ECU 16, they are processed by the ECU 16 using the preprogrammed algorithm, as represented in block 78. The processing by the ECU 16 includes comparing the second signal to a second predetermined temperature to determine a second temperature differential, and comparing the third signal to a third predetermined temperature to determine a third temperature differential. The ECU 16 then selectively operates at least one climate control device—e.g., the thermoelectric devices 14 or the HVAC systems 18—based on the second and third temperature differentials (see block 80).

The selective operation of the thermoelectric devices 14 and the HVAC systems 18 after the engine is running, combined with the selective operation of the fans 19 prior to the vehicle occupants entering the vehicle, helps to ensure a comfortable environment for the vehicle occupants. Moreover, additional elements such as retractable widow covers, light transmissivity adjustable glass, and/or added insulation, all help to keep the passenger compartment cool, even if the vehicle is parked in direct sunlight. Thus, the present invention provides an effective climate control system that allows for some individualized occupant control, and may allow for the elimination of a centralized vapor-compression air conditioning system.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A climate control system for controlling the climate in a passenger compartment of a vehicle having a seat, the climate control system comprising:
a first heating and cooling mechanism disposed in relation to the seat for selectively heating and cooling the seat;
a second heating and cooling mechanism for selectively heating and cooling ambient air in the vehicle passenger compartment;
a fan for facilitating movement of air out of the vehicle passenger compartment;
an electronic control system for controlling operation of the first heating and cooling mechanism, the second heating and cooling mechanism, and the fan; and
a signaling device for selectively signaling the electronic control system to activate and deactivate the fan prior to an occupant entering the vehicle.

2. The climate control system of claim 1, wherein the first and second heating and cooling mechanisms comprise thermoelectric devices, Stirling cycle devices, or a combination thereof.

3. The climate control system of claim 1, wherein the fan is a component of the second heating and cooling mechanism.

4. The climate control system of claim 1, wherein the signaling device comprises a first temperature sensor configured to sense the temperature of ambient air in the vehicle passenger compartment.

5. The climate control system of claim 1, wherein the signaling device comprises a timer configured to signal the electronic control system to activate the fan at a first predetermined time.

6. The climate control system of claim 1, wherein the signaling device includes a portion of a vehicle remote entry system.

7. The climate control system of claim 1, further comprising a second temperature sensor disposed in relation to the seat for sensing the temperature of a portion of the seat, and for sending an electronic signal related to the temperature sensed to the electronic control system.

8. The climate control system of claim 1, further comprising a manual controller configured for operation by a vehicle occupant, for controlling at least the first heating and cooling mechanism.

9. The climate control system of claim 1, further comprising light transmissivity adjustable glass configured for use in at least one vehicle window.

10. The climate control system of claim 1, further comprising a selectively retractable window cover having an extended position for covering at least a portion of a vehicle window, and a retracted position for storage of the cover.

11. The climate control system of claim 1, wherein the climate control system is configured to control the climate without use of a vapor-compression air conditioning system.

12. A climate control system for controlling the climate in the passenger compartment of a vehicle without a vapor-compression air conditioning system, the vehicle having a plurality of seats, the climate control system comprising:
a passenger compartment ventilation system including a fan for facilitating movement of air out of the vehicle passenger compartment prior to an occupant entering the vehicle;
a first set of heating and cooling mechanisms disposed in relation to the seats for selectively heating and cooling the seats;
a second set of heating and cooling mechanisms disposed in relation to the vehicle passenger compartment for selectively heating and cooling ambient air in the vehicle passenger compartment;
an electronic control system for controlling operation of the first set of heating and cooling mechanisms, the second set of heating and cooling mechanisms, and the fan; and
a signaling device for selectively signaling the electronic control system to activate and deactivate the fan prior to an occupant entering the vehicle.

13. The climate control system of claim 12, further comprising a plurality of temperature sensors disposed in various locations throughout the vehicle passenger compartment for sensing the ambient air temperature at the various locations and for signaling the electronic control system.

14. The climate control system of claim 12, further comprising a plurality of manual controllers, each of the manual controllers being configured for operation by a vehicle occupant for controlling at least a corresponding heating and cooling mechanism from the first set of heating and cooling mechanisms.

15. A method of controlling the climate in a passenger compartment an engine driven vehicle having a seat, the method comprising:
sensing the temperature of ambient air in the passenger compartment of the vehicle before the engine is turned on;
sending a first signal to an electronic control unit, the first signal being related to the temperature of the ambient air;
processing the first signal with the electronic control unit;
selectively operating a fan based on the processing of the first signal, the fan being configured to facilitate movement of air out of the passenger compartment of the vehicle;
sensing the temperature near an interface of a seated occupant and a seat after the engine is turned on;
sending a second signal to the electronic control unit, the second signal being related to the temperature near the interface;
sensing the temperature of ambient air in the passenger compartment of the vehicle after the engine is turned on;
sending a third signal to the electronic control unit, the third signal being related to the temperature of the ambient air;
processing the second and third signals with the electronic control unit; and
selectively operating at least one climate control device, chosen from a set of climate control devices, based on the processing by the electronic control unit, the set of climate control devices including a first heating and cooling mechanism disposed in relation to the seat for selectively heating and cooling the seat, and a second heating and cooling mechanism disposed in relation to the passenger compartment of the vehicle for selectively heating and cooling ambient air in the passenger compartment of the vehicle.

16. The method of claim 15, wherein processing the first signal comprises comparing the first signal with a first predetermined temperature to determine a first temperature differential.

17. The method of claim 16, wherein selectively operating the fan comprises activating the fan when the first temperature differential indicates that the temperature of the ambient air exceeds the first predetermined temperature.

18. The method of claim 15, wherein processing the second and third signals comprises comparing the second signal with a second predetermined temperature to determine a second temperature differential, and comparing the third signal to a third predetermined temperature to determine a third temperature differential.

19. The method of claim 18, wherein selectively operating at least one climate control device comprises selectively operating the first and second heating and cooling mechanisms based on the second and third temperature differentials.

20. The method of claim 15, further comprising selectively operating a retractable window cover based on the processing of the first signal.

21. The method of claim 15, further comprising providing light transmissivity adjustable glass for at least one vehicle window, and selectively providing electric current to the glass in the at least one vehicle window, thereby reducing infrared light penetration into the passenger compartment of the vehicle.
